(19) United States
(12) Patent Application Publication
(10) Pub. No.: US 2026/0195662 A1
(43) Pub. Date: Jul. 9, 2026

(54) AUTOMATED VALET PARKING SYSTEM

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP); Kazuhito ESHIMA, Toyota-shi (JP)

(73) Assignee: TOYOTA JIDOSHA KABUSHIKI KAISHA, Toyota-shi (JP)

(21) Appl. No.: 19/390,734

(22) Filed: Nov. 17, 2025

(30) Foreign Application Priority Data
Jan. 6, 2025 (JP) 2025-001889

(51) Int. Cl. G06Q 10/02; B60W 30/06; B60W 50/14

(52) U.S. Cl. CPC G06Q 10/02; B60W 30/06; B60W 50/14; B60W 2510/1005

(57) ABSTRACT

The automated valet parking system includes one or more processors and a storage device. The storage device stores a reservation database for managing AVP reservation data for each user. The appointment information includes information related to a service provided by AVP. The one or more processors are configured to acquire the reservation information of the target user from the reservation database, determine the condition of the vehicle state for starting AVP related to the reservation information of the target user according to the provision service in the reservation information of the target user, and disallow the start of AVP when the target vehicle does not satisfy the condition of the vehicle state when the request for starting AVP related to the reservation information of the target user is received.

### CROSS-REFERENCE TO RELATED APPLICATION

This application claims priority to Japanese Patent Application No. 2025-001889 filed on January 6, 2025. The disclosure of the above-identified application, including the specification, drawings, and claims, is incorporated by reference herein in its entirety.

### BACKGROUND

### 1. Technical Field

The present disclosure relates to an automated valet parking system for automated valet parking in a predetermined area.

### 2. Description of Related Art

German Patent Application Publication No. 102012222562 discloses a technique related to automated valet parking (AVP). A vehicle acquires route information from a parking lot and travels unmanned along the acquired route. Japanese Unexamined Patent Application Publication No. 2021-000974 (JP 2021-000974 A) discloses a technology related to a parking assistance system that autonomously moves a vehicle from a current position to a target position. The parking assistance system starts a driving process for controlling a driving device of the vehicle when there is an operation of a braking operator related to the braking of the vehicle and an input to a driving reception switch.

### SUMMARY

In recent years, it has been considered to apply the AVP not only to parking of vehicles but also to various scenes including various services to be provided. For example, it is conceivable to apply the AVP to the return of vehicles, including car washing and recharging, in the rental car business, and to apply the AVP to the transportation of completed vehicles, including the inspection process, in factories.

When a vehicle is simply parked using the AVP, the preferable vehicle state to start the AVP can be a determined state. However, when a certain service is to be provided during the execution of the AVP, it is conceivable that the preferable vehicle state to start the AVP is different, depending on the service to be provided. If the AVP is started when the vehicle is in an inappropriate state for the service to be provided, there is a possibility that the service may not be appropriately received. As a result, the smooth operation of the AVP may be hindered.

An object of the present disclosure is to provide a technique that enables smooth operation of AVP when various services are to be provided by the AVP.

One aspect of the present disclosure relates to an automated valet parking system for automated valet parking (AVP) in a predetermined area.

The automated valet parking system includes one or more processors and a storage device.

The storage device stores a reservation database that manages reservation information of the AVP for each user.

The reservation information includes information about a service to be provided by the AVP.

The one or more processors are configured to acquire the reservation information for a target user from the reservation database, determine a vehicle state condition for starting the AVP related to the reservation information for the target user according to the service to be provided in the reservation information for the target user, and when a request to start the AVP related to the reservation information for the target user is received, not permit a start of the AVP if a target vehicle does not satisfy the vehicle state condition.

According to the present disclosure, a vehicle state condition for starting the AVP related to the reservation information for the target user is determined according to the service to be provided in the reservation information for the target user. It is not permitted to start the AVP if the target vehicle does not satisfy the vehicle state condition, even if the target user makes a request to start the AVP. Accordingly, since the AVP is not started when the vehicle is in an inappropriate state, the AVP can be smoothly operated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for explaining an entire AVP performed by an automated valet parking system according to the present embodiment;

FIG. 2A is a conceptual diagram for explaining an outline of technical features of an automated valet parking system according to the present embodiment;

FIG. 2B is a conceptual diagram for explaining an outline of technical features of an automated valet parking system according to the present embodiment;

FIG. 3 is a diagram illustrating an example of a hardware configuration of the automated valet parking system according to the present embodiment;

FIG. 4 is a flowchart showing a process flow of a process executed by the managing system in relation to technical features of the automated valet parking system according to the present embodiment; and

FIG. 5 is a flowchart illustrating a processing flow of additional processing executed by the management system in relation to technical features of the automated valet parking system according to the present embodiment.

### DETAILED DESCRIPTION OF EMBODIMENTS

Hereinafter, embodiments of the present disclosure will be described with reference to the drawings. In the drawings, the same or corresponding parts are denoted by the same reference numerals, and the description thereof is simplified or omitted.

### 1 Automated valet parking system

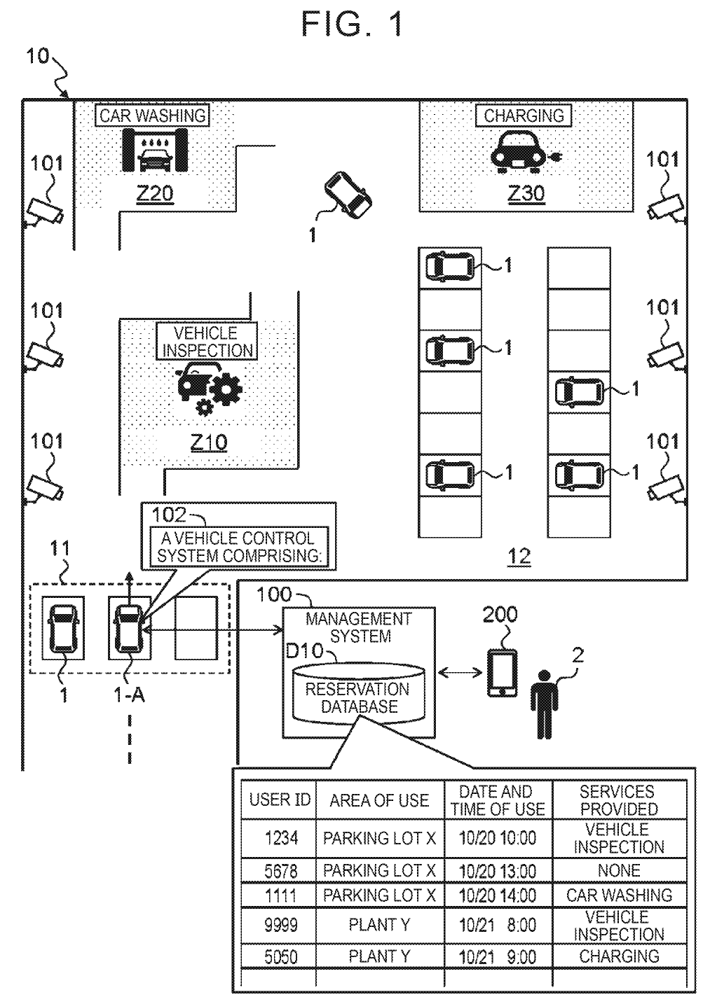

The automated valet parking system according to the present embodiment performs AVP in a predetermined area where various services are provided. FIG. 1 is a conceptual diagram for explaining an entire AVP performed by an automated valet parking system according to the present embodiment. The automated valet parking system according to the present embodiment includes a management system 100, a sensor 101 disposed in the area 10, and a vehicle control system 102 included in the vehicle 1.

The area 10 includes at least one area for providing service to the vehicle 1. When the vehicle 1 enters any area, a service corresponding to the area entered is provided to the vehicle 1. Examples of the service include vehicle inspection, car washing, charging, refueling, component replacement, and replenishment of coolant and washer liquid. In the embodiment shown in FIG. 1, the area 10 includes a first area Z10 for providing a vehicle-inspection service, a second area Z20 for providing a car-washing service, and a third area Z30 for providing a charge service. The area 10 is, for example, a parking lot of a rental car office, a parking lot of a commercial facility, a site of an airport, a site of a factory, or the like.

When receiving a start request from the user 2, AVP according to the present embodiment identifies the target vehicle 1-A from the vehicle 1 stopped at the getting-off location 11, moves the target vehicle 1-A to the parking area 12, and parks it in the parking space. In the present embodiment, the user 2 may be an employee of a rental car office, an employee of a factory, or the like in addition to a general user. In addition, a known suitable technique may be adopted as a method of identifying the target vehicle 1-A. Further, AVP according to the present embodiment provides servicing to the target vehicle 1-A while AVP is being executed in accordance with the reservation data of AVP of the user 2. Therefore, the reservation information of AVP of the user 2 includes information related to the service provided by AVP. For example, when the provision service is "car washing" in the reservation information, AVP according to the present embodiment moves the target vehicle 1-A to enter the second area Z20 and then to the parking area 12.

AVP according to the present embodiment may be implemented in a plurality of areas 10. In particular, the services provided in each area 10 may be different from each other. Thus, the reserved information of AVP of the user 2 may include information of the use area in the plurality of areas 10.

The management system 100 manages AVP in the area 10. The management system 100 is connected to the sensor 101 via a communication network. The sensor 101 detects the position and the state of each vehicle 1 in the area 10. The sensor 101 includes, for example, a camera, a radar, a LiDAR (light detection and ranging), and the like. The management system 100 manages information of each vehicle 1 in the area 10 based on detection information acquired using the sensor 101.

The management system 100 is connected to the user terminal 200 of the user 2 via a communication network. The user terminal 200 is, for example, a computing device (e.g., smart phone, tablet, wearable device, personal computer) on which a particular application associated with AVP is installed. For example, the user terminal 200 may be a dedicated device for AVP. The user 2 reserves the use of AVP by operating the user terminal 200. The reservation information related to the use reservation is transmitted to the management system 100. The management system 100 stores a reservation database D10 for managing AVP reservation data for each user 2. For example, as illustrated in FIG. 1, the reservation database D10 manages the reservation data of each user 2 by identifying each user 2 by a user ID. In the present embodiment, AVP reservation information includes information on the use area, the use date and time, and the provision service. The offering service may be selectable when the user 2 is booking AVP use (e.g., choosing whether to perform car washing or recharging in a commercial facility) or may be essential in AVP in the area 10 (e.g., performing vehicle inspections in a factory).

The management system 100 sets the user 2 to be subjected to AVP in the near future as the target user 2-A, and acquires the reservation data of the target user 2-A from the reservation database D10. The target user 2-A is, for example, a user 2 whose date and time of use is within a certain period of time from the current time, or a user 2 whose current position is within a certain range from the area 10.

When the user 2 intends to perform AVP, he/she stops the vehicle 1 at the getting-off location 11 and gets off the vehicle 1. Thereafter, the user 2 operates the user terminal 200 to make an AVP initiation request.

When receiving a request to start AVP from the target user 2-A, the management system 100 starts communication with the target vehicle 1-A and performs AVP of the target vehicle 1-A according to the reservation information of the target user 2-A. More specifically, the management system 100 transmits the instruction information of AVP to the target vehicle 1-A on the basis of the management data regarding each vehicle 1 and each area in the area 10. The vehicle control system 102 of the target vehicle 1-A controls the traveling device of the target vehicle 1-A and the in-vehicle equipment according to the received instruction information. In this way, AVP by the automated valet parking system according to the present embodiment is performed.

### 2 Overview

Next, an outline of technical features of the automated valet parking system according to the present embodiment will be described. As described above, in the automated valet parking system according to the present embodiment, some servicing may be provided in the area 10 during the execution of AVP. Conventionally, a preferred vehicle state for starting AVP can be set to a predetermined state when only parking of the target vehicle 1-A is performed by AVP. For example, preferred vehicle conditions in this case include the shift position being parked, the window being closed, the power being turned off, the door being locked, the door mirror being open, and the like. However, when providing a service during the execution of AVP, it is conceivable that the preferred vehicular conditions when starting AVP differ depending on the provided service. For example, a case where the provision service is "vehicle inspection" is considered. Here, when starting AVP, the shifting position is preferably neutral rather than parking. This is because, in the inspection line of the vehicle inspection, the inspection is performed in a state where the shift position is neutral. Further, for example, a case where the provision service is "car washing" is considered. Here, when AVP is started, the door mirror is preferably closed. This is to prevent interference with the car washing machine during car washing. If AVP is started in an illegal condition with respect to the provided service, there is a possibility that the service may not be properly received. Consequently, the smooth operation of AVP may be hindered.

Therefore, in order to address the above-described problem, the automated valet parking system according to the present embodiment is configured to determine the condition of the vehicle condition for starting AVP related to the reservation information of the target user 2-A in accordance with the provision service in the reservation information of the target user 2-A. The automated valet parking system according to the present embodiment is configured such that, upon receiving a request to start a AVP related to the reservation information of the target user 2-A, the start of AVP is not permitted when the target vehicle 1-A does not satisfy the condition of the vehicle condition.

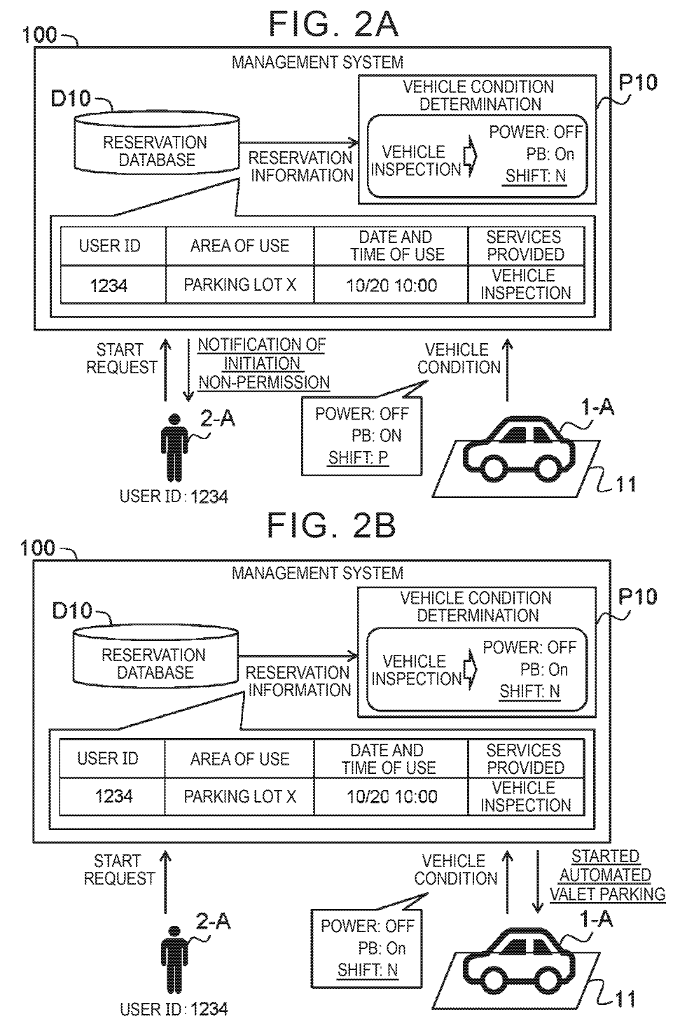

FIGS. 2A and 2B are conceptual diagrams for explaining an outline of technical features of the automated valet parking system according to the present embodiment. The management system 100 identifies the target user 2-A and acquires the reservation data of the target user 2-A from the reservation database D10. The management system 100 executes a vehicle state condition determination process P10. In the vehicle state condition determination process P10, the management system 100 determines a condition of the vehicle state for starting AVP related to the reservation information of the target user 2-A. In the example illustrated in FIGS. 2A and 2B, the provision service is "vehicle inspection" in the reservation information of the target user 2-A, and the management system 100 determines that the power is off, that the parking brake (PB) is on, that the shift position is neutral (N), and that AVP related to the reservation information of the target user 2-A is to be started. However, the example illustrated in FIG. 2A and the example illustrated in FIG. 2B are examples, and the condition of the vehicle-state for starting AVP determined in accordance with the provision service may be appropriately set in accordance with the environment to which the present embodiment is applied. When receiving a request for starting an AVP related to the appointment information of the target user 2-A, the management system 100 communicates with the target vehicle 1-A and acquires the present vehicle status of the target vehicle 1-A.

In FIG. 2A, the present vehicle condition of the target vehicle 1-A is the power-off, the parking brake (PB) is on, and the shift position is the parking (P). That is, in FIG. 2A, since the shift position is not neutral (N), the target vehicle 1-A does not satisfy the condition of the vehicle condition for starting AVP. Therefore, as shown in FIG. 2A, the management system 100 does not allow AVP to be started. The management system 100 notifies the target user 2-A that AVP is not permitted to be started. For example, the management system 100 displays a message indicating that the user terminal 200 of the target user 2-A has not been allowed to start AVP.

In FIG. 2B, the present vehicle condition of the target vehicle 1-A is the power-off, the parking brake (PB) is on, and the shift position is neutral (N). That is, in FIG. 2B, the target vehicle 1-A satisfies the condition of the vehicle condition for starting AVP. Thus, as shown in FIG. 2B, the management system 100 initiates an AVP. The management system 100 may notify the target user 2-A that AVP is started.

As described above, according to the automated valet parking system of the present embodiment, the condition of the vehicle condition for starting AVP related to the reservation information of the target user 2-A is determined according to the provision service in the reservation information of the target user 2-A. Even if the target user 2-A makes an AVP start request, the start of AVP is not permitted when the target vehicle 1-A does not satisfy the condition of the vehicle condition. Accordingly, since AVP is not started when the vehicle is in an unauthorized state, AVP can be smoothly operated.

The automated valet parking system according to the present embodiment may be further configured to notify the target user 2-A of the condition of the vehicle state determined by the vehicle state condition determination process P10 when the target vehicle 1-A enters the area 10 or when the target vehicle 1-A arrives at the getting-off location 11 of the area 10. For example, the management system 100 displays a list of the conditions of the vehicle state determined by the vehicle state condition determination process P10 on the user terminal 200 or a display device mounted on the target vehicle 1-A. With this configuration, since the target user 2-A can determine the condition of the vehicle condition in advance, it is possible to reduce the frequency at which AVP is not permitted to be started.

The automated valet parking system according to the present embodiment may further be configured to notify the target user 2-A of a condition that the target vehicle 1-A does not satisfy the condition of the vehicle state determined by the vehicle state condition determination process P10 when AVP is not permitted to be started. For example, as shown in FIG. 2A, the management system 100 notifies the target user 2-A that the position of the shift position is not satisfied. For example, the management system 100 displays a message such as "please set the shift position to N" or a list of conditions that are not satisfied on the user terminal 200 or a display device mounted on the target vehicle 1-A. With this configuration, the target user 2-A can grasp which condition is not satisfied, and can operate the target vehicle 1-A so as to satisfy the condition. Then, the target user 2-A can start AVP by making a start request again after operating the target vehicle 1-A so as to satisfy the condition.

In addition, the automated valet parking system according to the present embodiment may be further configured such that, when the start of AVP is not permitted, when the start of AVP can be permitted by changing the provided service, a notification requesting the change of the provided service is executed on the target user 2-A. The automated valet parking system may be configured to initiate an AVP when the offered service is changed. For example, in the cases illustrated in FIG. 2A, the management system 100 displays, on the user terminal 200 or the display device mounted on the target vehicle 1-A, a message inquiring whether the provided service may be set to "none". Alternatively, the management system 100 displays, on the user terminal 200, a list of providing services (which may include "none") that satisfy the condition in the present vehicle condition of the target vehicle 1-A, and requests selection of the providing service of the change destination from the list. With such a configuration, it is possible to reduce the troublesomeness of the target user 2-A because the target user 2-A can take a unit for starting AVP by changing the provided service.

### 3 Hardware configuration

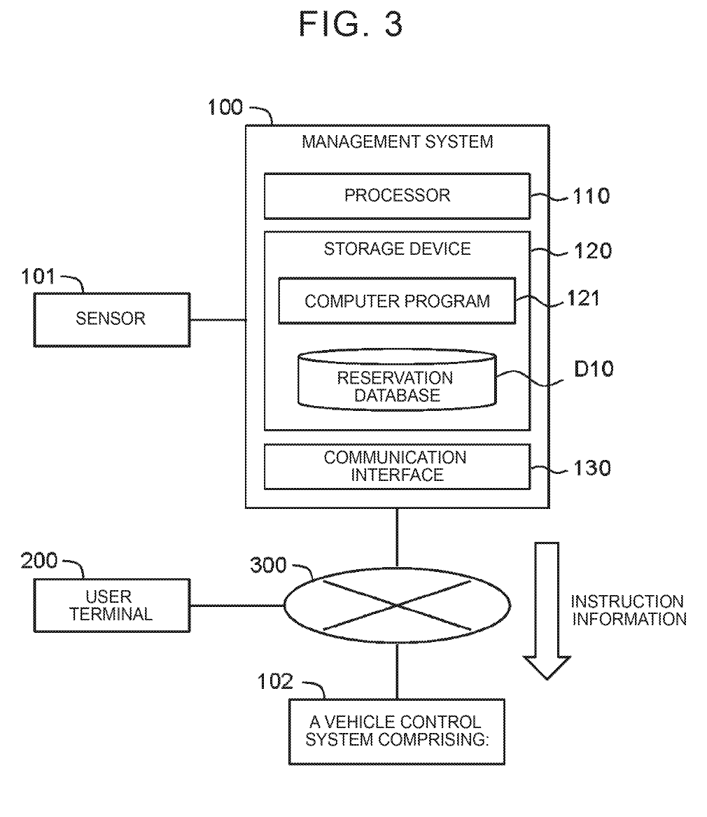

FIG. 3 is a diagram illustrating an example of a hardware configuration of the automated valet parking system 3 according to the present embodiment. The sensor 101 is communicatively coupled to the management system 100. The management system 100 is connected to the communication network 300 and communicates with the user terminal 200 and the vehicle control system 102. The management system 100 generates instruction information for traveling management of the vehicle 1, and transmits the generated instruction information to the vehicle control system 102.

The management system 100 includes one or more processors 110 (hereinafter simply referred to as processors 110), one or more storage devices 120 (hereinafter simply referred to as storage devices 120), and a communication interface 130.

The processor 110 executes various processes. The processor 110 includes, for example, a general-purpose processor, an application-specific processor, a CPU (central processing unit), a GPU (graphics processing unit), an ASIC (application specific integrated circuit), an FPGA (field-programmable gate array), an integrated circuit, a conventional circuit, and one or more combinations thereof. The processor 110 may also be referred to as a processing circuitry. Processing circuitry is hardware programmed to implement the functions of the management system 100 or hardware executing the functions of the management system 100.

The storage device 120 stores various kinds of information necessary for execution of processing by the processor 110. The storage device 120 stores, for example, various kinds of information necessary for execution of processing by the processor 110. The storage device 120 is constituted by a recording medium such as RAM (random access memory), ROM (read only memory), SSD (solid state drive), HDD (hard disk drive), and the like. The storage device 120 stores a computer program 121 executable by the processor 110 and a reservation database D10. The computer program 121 includes a plurality of instruction codes describing processing to be executed by the processor 110. The computer program 121 is recorded in a computer-readable recording medium. The functions of the management system 100 are realized by the cooperation of the processor 110 executing the computer program 121 and the storage device 120. For example, the vehicle state condition determination process P10 is executed.

The communication interface 130 is an interface for connecting to the communication network 300 and communicating with a device external to the management system 100. The communication interface 130 includes, for example, the Internet, a mobile communication network, a LAN, and the like. The management system 100 transmits and receives information to and from the user terminal 200 and the vehicle control system 102 via the communication interface 130.

The vehicle control system 102 is a system that controls the vehicle 1. In particular, when the instruction information is received from the management system 100, the vehicle control system 102 controls the traveling device and the in-vehicle device (for example, a door mirror, a lighting device, or the like) of the vehicle 1 in accordance with the received instruction information. The vehicle control system 102 includes, for example, a communication device that connects to the communication network 300 and transmits and receives information, an in-vehicle sensor that detects a traveling environment of the vehicle 1, a control device that controls the vehicle 1 based on various kinds of information, a traveling device that provides a traveling function (e.g., driving, braking, steering) of the vehicle 1, and various in-vehicle devices. The control device is, for example, an electronic control unit (ECU). The control device may be a combination of a plurality of ECU. Alternatively, the controller may be a kit (AVP kit) for the functions provided by the management system 100.

### 4 Process flow

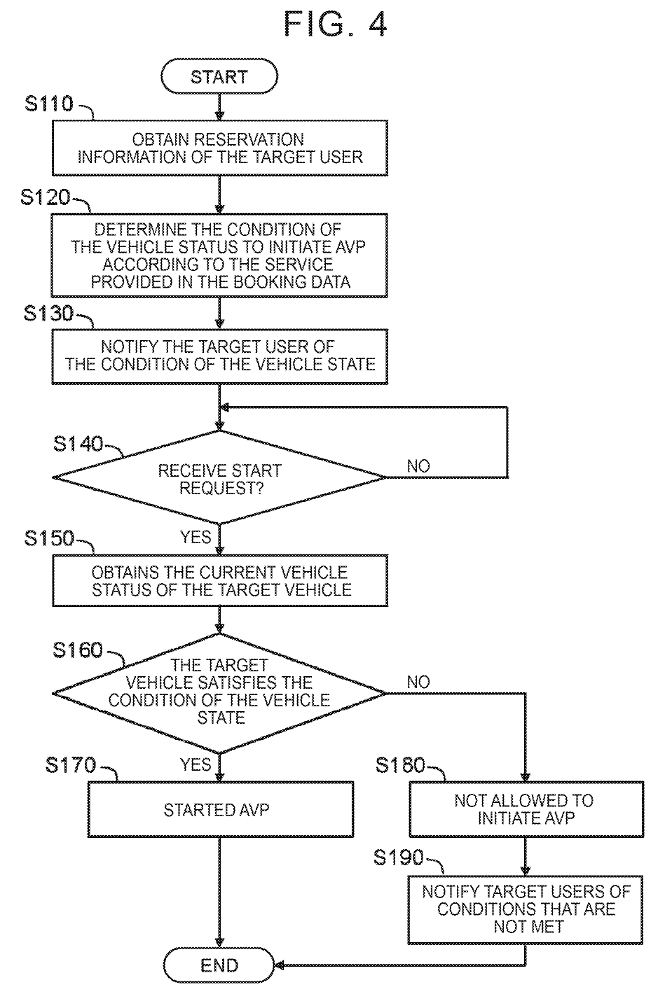

FIG. 4 is a flowchart illustrating a processing flow of processing executed by the management system 100 (more specifically, the processor 110) in relation to the technical features of the automated valet parking system 3 according to the present embodiment. The process illustrated in FIG. 4 starts, for example, when the management system 100 identifies a target user 2-A.

In S110, the management system 100 acquires the reservation information of the target user 2-A from the reservation database D10. For example, the management system 100 acquires the reservation data of the target user 2-A by using the user ID of the target user 2-A to refer to the reservation database D10.

Next, in S120, the management system 100 executes a vehicle state condition determination process P10, and determines a condition of a vehicle state for starting AVP in accordance with the provision service in the reservation information of the target user 2-A.

Next, in S130, the management system 100 notifies the target user 2-A of the condition of the vehicle state determined by the vehicle state condition determination process P10. In particular, the management system 100 may be configured to provide a notification to the target user 2-A when the target vehicle 1-A enters the area 10 or when the target vehicle 1-A arrives at the getting-off location 11.

Next, in S140, the management system 100 waits for an initiation request from the target user 2-A. When the management system 100 receives a start request from the target user 2-A (S140; Yes), the process proceeds to S150.

In S150, the management system 100 obtains the present vehicle status of the target vehicle 1-A.

Next, in S160, the management system 100 determines whether or not the target vehicle 1-A satisfies the condition of the vehicle state determined by the vehicle state condition determination process P10.

When the target vehicle 1-A satisfies the condition of the vehicle condition (S160; Yes), the management system 100 starts AVP (S170).

When the target vehicle 1-A does not satisfy the condition of the vehicle condition (S160; No), the management system 100 determines that AVP is not permitted to be started (S180). Furthermore, the management system 100 notifies the target user 2-A of the condition that the target vehicle 1-A does not satisfy the condition of the vehicle state determined by the vehicle state condition determination process P10 (S190), and ends the processing without starting AVP.

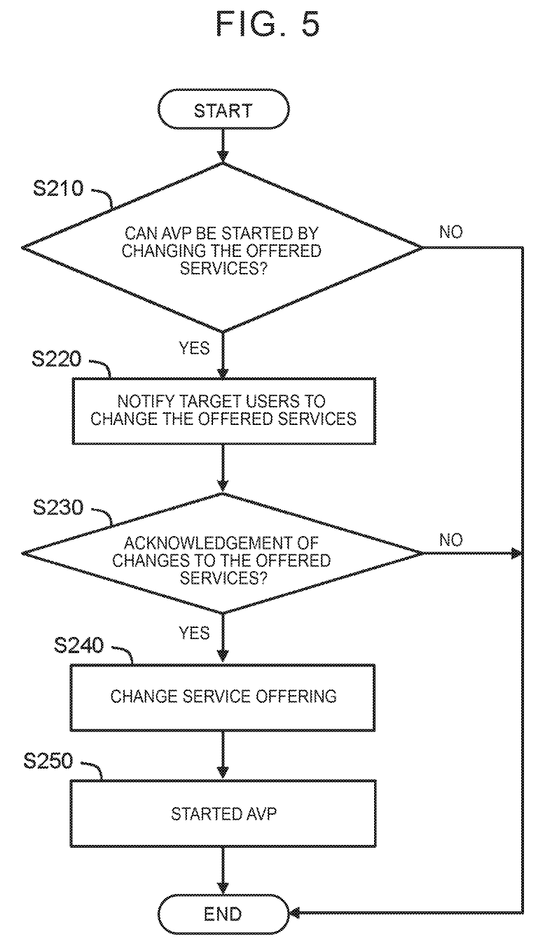

As described above, the automated valet parking system 3 according to the present embodiment may be configured such that, when the start of AVP is not permitted, when the start of AVP can be permitted by the change of the provided service, a notification requesting the change of the provided service is executed on the target user 2-A. The automated valet parking system 3 may be configured to initiate an AVP when the provision service is changed. FIG. 5 is a flowchart illustrating a processing flow of processing executed by the management system 100 (more specifically, the processor 110) in order to realize this configuration. The process sequence illustrated in FIG. 5 is started after the process according to S190 illustrated in FIG. 4 is executed, for example.

In S210, the management system 100 determines whether AVP can be started by changing the offered service. If AVP cannot be permitted to be started (S210; No) even if the provided-service is changed, the process ends without starting AVP. When AVP can be started by changing the provided service (S210; Yes), the management system 100 notifies the target user 2-A of the request for changing the provided service (S220).

After S220, at the next S230, the management system 100 determines whether the target user 2-A has accepted the change of the provided service. When the target user 2-A refuses to change the provision service (S230; No), the process ends without starting AVP. When the target user 2-A accepts the change of the provided service (S230; Yes), the management system 100 changes the provided service of the target user 2-A (S240) and starts AVP (S250).

What is claimed is:

1. An automated valet parking system for automated valet parking in a predetermined area, comprising:
one or more processors; and
a storage device that stores a reservation database that manages reservation information of the automated valet parking for each user, wherein:
the reservation information includes information about a service to be provided by the automated valet parking; and
the one or more processors are configured to
acquire the reservation information for a target user from the reservation database,
determine a vehicle state condition for starting the automated valet parking related to the reservation information for the target user according to the service to be provided in the reservation information for the target user, and
when a request to start the automated valet parking related to the reservation information for the target user is received, not permit a start of the automated valet parking if a target vehicle does not satisfy the vehicle state condition.

2. The automated valet parking system according to claim 1, wherein the vehicle state condition includes a condition related to a shift position.

3. The automated valet parking system according to claim 1, wherein the one or more processors are further configured to when the target vehicle enters the predetermined area or when the target vehicle arrives at a drop-off location of the predetermined area, notify the target user of the vehicle state condition.

4. The automated valet parking system according to claim 1, wherein the one or more processors are further configured to when the start of the automated valet parking is not permitted, notify the target user of a condition that the target vehicle does not satisfy, of the vehicle state condition.

5. The automated valet parking system according to claim 1, wherein the one or more processors are further configured to:
when the start of the automated valet parking is not permitted, notify the target user to change the service to be provided if the start of the automated valet parking is permitted by changing the service to be provided; and
when the service to be provided is changed, start the automated valet parking.
